(19) United States
(12) Patent Application Publication
(10) Pub. No.: US 2011/0132819 A1
(43) Pub. Date: Jun. 9, 2011

(54) Delivery System for the Removal of Contaminants in Lubricating and Hydraulic Fluids

(76) Inventors: David Scott Kolstad, White Bear Lake, MN (US); John Henry Burban, Lake Elmo, MN (US); Craig J. Cuta, Stillwater, MN (US); Gregory James Livingstone, Tucson, AZ (US); Brian T. Thompson, St. Pete Beach, FL (US)

(21) Appl. No.: 12/882,065

(22) Filed: Sep. 14, 2010

Related U.S. Application Data
(60) Provisional application No. 61/242,357, filed on Sep. 14, 2009.

(51) Int. Cl. F16N 39/06; F01M 11/03; B01D 15/04; B01D 35/02; F15B 21/04

(52) U.S. Cl. 210/97; 210/167.04; 210/282; 210/232; 210/455; 210/238

(57) ABSTRACT

A delivery system for removing contaminants from lubricating and hydraulic fluids. The delivery system can include a reusable sleeve and a first end cap and a second end cap coupled to the reusable sleeve. The delivery system can also include a disposable absorbent cartridge containing absorbent material capable of removing contaminants from lubricating and hydraulic fluids. The disposable absorbent cartridge can be removeably positioned inside the reusable sleeve between the first end cap and the second end cap. The disposable absorbent cartridge can be constructed of a material permeable to the lubricating and hydraulic fluids.

### RELATED APPLICATIONS

This application claims priority under 35 U.S.C. §119 to U.S. Provisional Patent Application No. 61/242,357 filed on Sept. 14, 2009, the entire contents of which is incorporated herein by reference.

BACKGROUND

Gas turbines, steam turbines and other related hydraulic systems often employ phosphate ester fluid lubricants as the primary lubricating material. Other lubricants that may be used include isopropylphenyl phosphate ester (IPPP) and tertiary-butylphenyl phosphate (TBPP). Phosphate ester fluid is vulnerable to thermal degradation, which results in the generation of acid contaminants in the form of phosphorus and phosphoric acids, along with a variety of metal salts from acidic corrosion of internal gas turbine metals. Various materials and methods have been developed to cleanse phosphate ester lubricant contaminated with metal material and acids. One conventional method uses anionic resin to remove the metal compounds and the acids to provide a contaminant-free, reusable lubricating fluid.

Surface and depth media filters are designed to capture particles at an engineered size range. The performance of the filters can be altered by the use of various media selections and design characteristics. However, these filters are generally not able to effectively remove oil degradation products from lubricating and hydraulic oils. This is due to the fact that oil degradation products (including both degraded additive components and basestocks) are often in solution when the fluid is at the operating temperature. When the fluid cools and the degradation products precipitate out of the fluid, they are often less than about one micron in size, which is smaller than the currently utilized surface and depth media filtration technologies.

A recent invention involving a specially-designed adsorptive resin media with acrylamide functionality is, described in U.S. Provisional Patent Application No. 61/169,964 in the names of Wooton et al., the entire contents of which is incorporated herein by reference. This resin media has been successfully demonstrated to remove degradation products from lubricating and hydraulic fluids. This resin media can remove products while they are both in suspension and in solution, and has exhibited the ability to significantly extend the life of fluids and solve issues such as the formation of sludge and varnish deposits. Other types of resin media have been used for similar purposes of removing contaminants from lubricating and hydraulic fluids, as described in U.S. Patent Application Publication No. 2009/0001023 in the names of Dufresne et al., U.S. Pat. No. 6,358,895, and U.S. Pat. No. 5,661,117, the entire contents of which are incorporated herein by reference.

FIGS. 1A-1D illustrate a prior art delivery vehicle for adsorptive resin media including a vessel 10 positioned within a housing 12. The vessel 10 can be generally constructed of a metal or a polymeric material. The vessel 10 can house a resin material 14 and can include end caps 16 and perforations or screens 18 on either or both ends to allow a fluid (e.g., lubricating or hydraulic fluid) to flow axially through the resin media 14. Alternatively, walls 20 of the vessel 10 can be perforated and the vessel 10 can include a perforated core (not shown) with the resin material 14 placed between the core and vessel wall 14, where the fluid flows radially through the resin material 14. As the fluid passes through the resin material 14, contaminants are adsorbed onto or removed by the resin material 14. In either of these cases, the capacity of the resin material 14 is finite and once exhausted, it can no longer remove any additional contaminants. At such time, the entire vessel 10 containing the resin material 14 must be removed from the housing 12, disposed of, and replaced with a new vessel containing fresh resin. This practice increases the cost of employing the resin technology, because the vessel 10 and the end caps 16, which are expensive to manufacture, are not re-used. In addition, this practice wastes materials. Further, these products are not always suitable for disposal and are often required to be shipped back to the manufacture for recycling or re-use. The energy required to both manufacture and transport the spent and contaminated vessels is high, making such a process for re-using the materials not environmentally friendly or economically attractive.

### SUMMARY

In light of the problems discussed above, there is a need in the marketplace to improve upon the delivery of these types of resins and other absorbent materials that overcomes the disposal and waste issues associated with the current state of the art of providing these resins and other absorbent materials.

Some embodiments of the invention provide a delivery system for removing contaminants from lubricating and hydraulic fluids. The delivery system can include a reusable sleeve and a first end cap and a second end cap coupled to the reusable sleeve. The delivery system can also include a disposable absorbent cartridge containing absorbent material capable of removing contaminants from lubricating and hydraulic fluids. The disposable absorbent cartridge can be removeably positioned inside the reusable sleeve between the first end cap and the second end cap. In some embodiments, the disposable absorbent cartridge can be constructed of one or more of a needle-punched polymeric felt, a polymeric screen, and a non-woven and calendared polymeric media. In some embodiments, the disposable absorbent cartridge can be manufactured in a cylindrical shape, with or without a handle, or in a conical shape.

### DESCRIPTION OF THE DRAWINGS

FIGS. 1A-1D are partial cross-sectional, perspective, and end views of a prior art delivery vehicle for resin material.

FIGS. 2A-2F are end, perspective, and partial cross-sectional views of a delivery vehicle for absorbent material according to one embodiment of the invention.

FIGS. 3A-3B are perspective and partial cross-sectional views of a delivery vehicle for absorbent material with a handle according to another embodiment of the invention.

FIGS. 4A-4F are end, perspective, and partial cross-sectional views of a delivery vehicle for absorbent material according to yet another embodiment of the invention.

FIGS. 5A-5E are side, cross-sectional views of a delivery vehicle for absorbent material according to yet another embodiment of the invention.

FIG. 6 is a schematic view of a lubricating or hydraulic fluid distribution system including the delivery vehicle of FIG. 5.

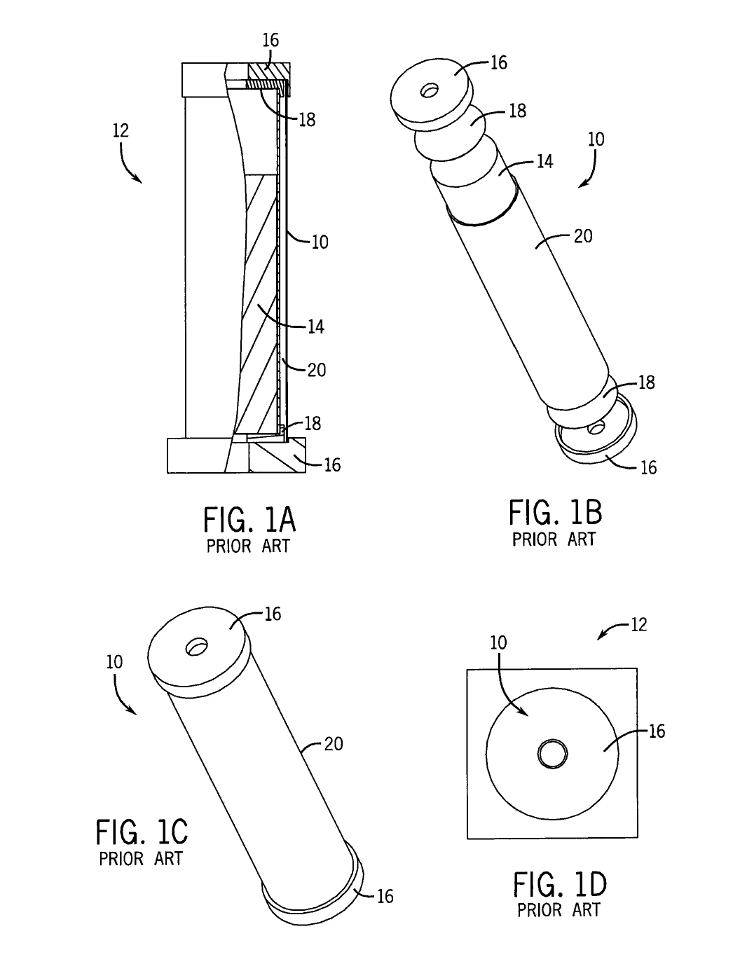

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to, physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

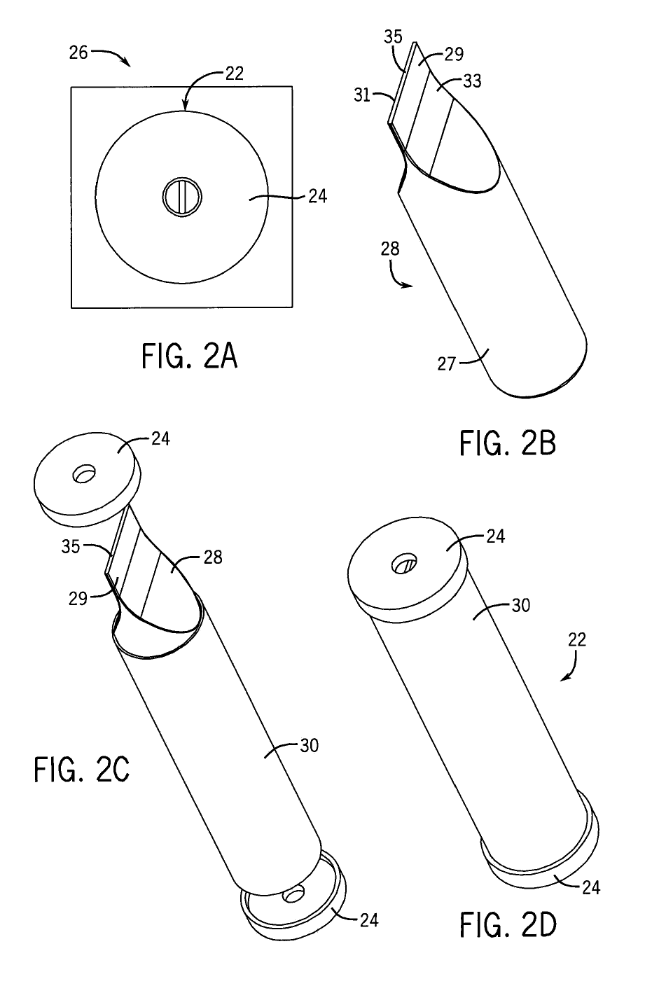

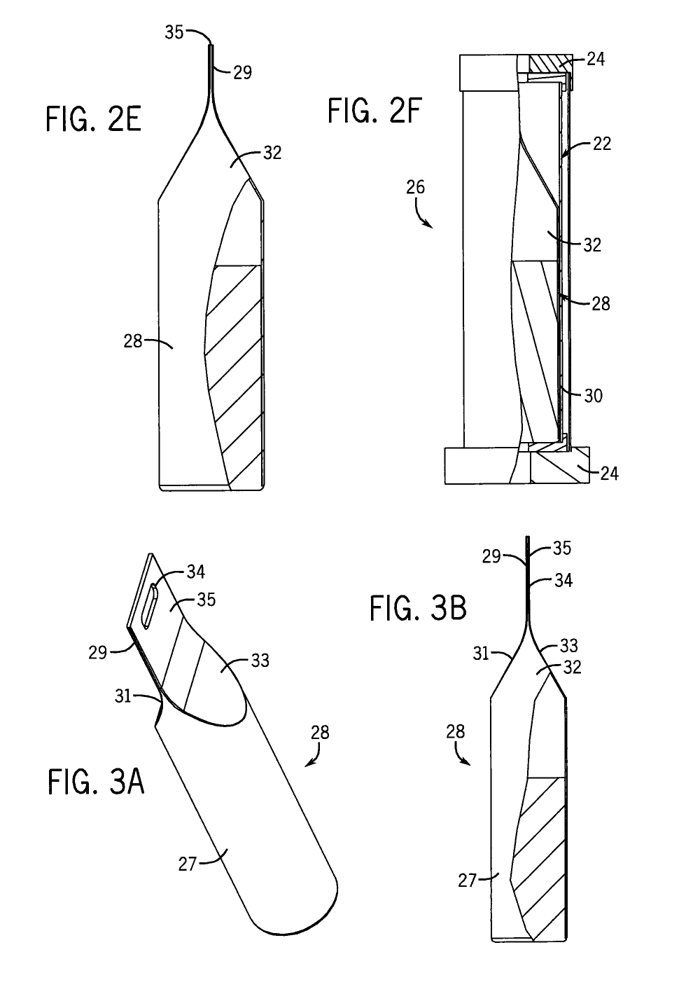

Some embodiments of the invention provide a delivery system that can offer a more environmentally-friendly and cost effective method of utilizing resin or other absorbent material technology compared to conventional delivery vehicles. As shown in FIG. 2D, the delivery system can include a reusable sleeve 22 and end caps 24. As shown in FIG. 2F, the reusable sleeve 22 and the end caps 24 can be placed inside of a housing 26. As shown in FIG. 2C, a disposable absorbent cartridge 28 can be placed within sidewalls 30 of the reusable sleeve 22. Both the reusable sleeve 22 and the disposable absorbent cartridge 28 can be cylindrical in shape, in some embodiments. The disposable absorbent cartridge 28 can include a cost-effective porous filtration material 32 that is seamed together to make a substantially or completely enclosed space filled with adsorptive resin material. When placed inside of the reusable sleeve 22, the disposable absorbent cartridge 28 can conform to the sidewalls 30 of the inner diameter of the reusable sleeve 22 due to its flexible nature and can substantially or completely fill the cross-sectional area of the inner space of the reusable sleeve 22. The disposable absorbent cartridge 28 can be completely filled with absorbent material or some space can be left to allow for volume expansion of the absorbent. In some embodiments, the disposable absorbent cartridge 28 can contain ion exchange resin. Fluid flow through the housing 26 of FIG. 2F can be from bottom to top or from top to bottom.

In some embodiments, the disposable absorbent cartridge 28 can reused and refilled a number of times before being disposed of. The absorbent cartridge 28 can be removed from the sleeve 22 and a top portion 29 can be opened. As shown in FIG. 2B, the disposable absorbent cartridge 28 can include a main cylindrical portion 27, a first flap 31, and a second flap 33. The first flap 31 and the second flap 33 can be joined to seal the absorbent material within the disposable absorbent cartridge 28.

In some embodiments, the first flap 31 and the second flap 33 can be joined by a closure device 35, such as hook and loop fastener, clips, brackets, etc. The closure device 35 can be opened in order to dispose of the spent absorbent material and to refill the disposable absorbent cartridge 28 with new absorbent material. For example, the spent resin can be poured out of the top portion 29 and new resin can be added back into the absorbent cartridge 28. The top portion 29 can then be closed again using the closure device 35, and the absorbent cartridge 28 can be positioned back inside the reusable sleeve 22. The disposable absorbent cartridge 28 can be refilled in the field, which can result in less waste and handling of spent cartridges.

In general, the types of resins or other adsorbent materials suitable for use in conjunction with embodiments of the invention include, but are not limited to, ion exchange resins based on polyacrylamide, polyacrylate or polystyrene polymers, generally cross-linked to improve performance; fuller's earth, diatomeaceous earth, bentonite and other types of clays; activated alumina; silica gel; alumino-silicate; activated carbon and modified activated carbon; and magnesium silicates.

In some embodiments, the entire disposable absorbent cartridge 28 can be constructed of a material permeable to lubricating and hydraulic fluids. In other embodiments, only a portion of the disposable absorbent cartridge 28 is permeable, such as the end portions of the cartridge, with the side walls being constructed of a non-porous material. Porous filtration media 32 that is suitable to be used can include, but is not limited to, one or more of the following: needle punched polymeric felts, polymeric screens, and non-woven and calendared polymeric media. The properties of the porous filtration media 32 can be strong enough to support the weight of the resin, porous enough to allow for the passage of the fluid being treated yet retain the resin, and made of materials whose chemical and temperature compatibility are consistent with the chemistry of the fluids being treated and conventional operating temperatures. A method for seaming the porous filtration media 32 can include, but is not limited to, one or more of the following: sewing, sonic welding, vibration welding, heat seaming, and gluing with adhesives.

As shown in FIGS. 3A-3B, another embodiment of the invention provides a handle 34 on the top portion 29 of the disposable absorbent cartridge 28 to facilitate its removal from the reusable sleeve 22. This can be accomplished in several different ways, including incorporating the handle 34 feature into the porous filtration media 32 or welding or adhering the handle 34 to the filtration media 32.

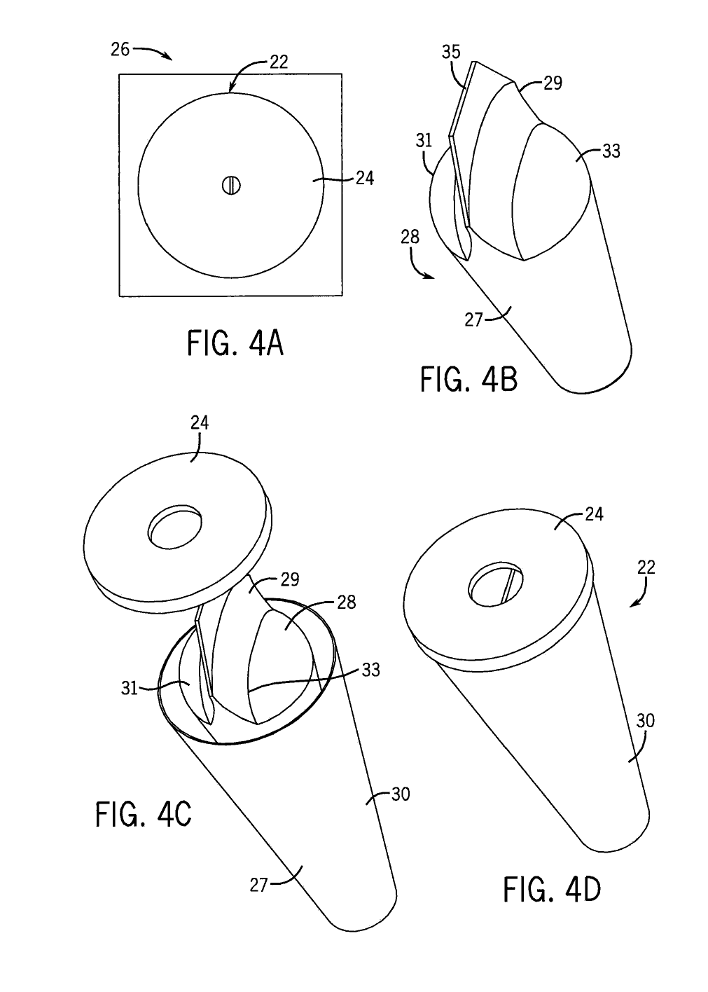

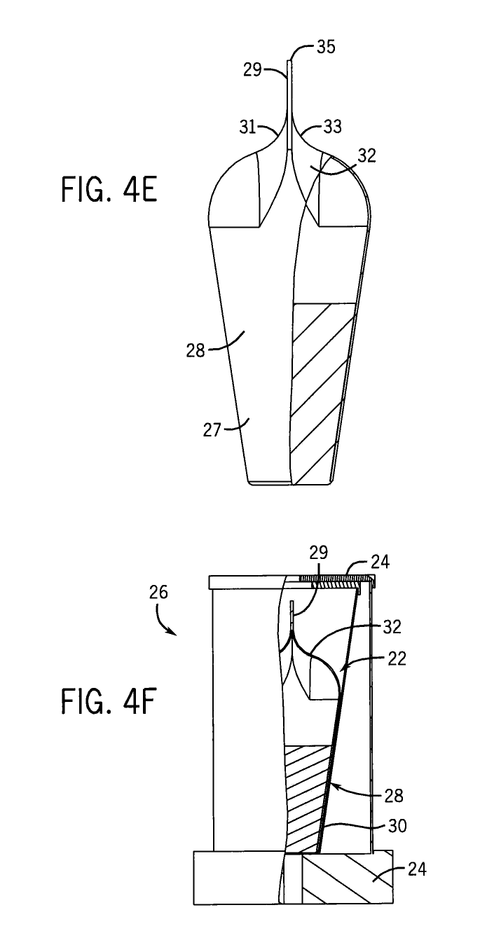

As shown in FIGS. 4A-4F, another embodiment of the invention provides a geometrical shape of the reusable sleeve 22 and the disposable absorbent cartridge 28 that facilitates the removal of the cartridge 28 from the reusable sleeve 22. With a cylindrical sleeve/cartridge, the interference between the two components continues until the disposable absorbent cartridge 28 is completely removed from the reusable sleeve 22. A geometry that would reduce the extent of this interference can be a conically-shaped sleeve 22 and a conically-shaped disposable absorbent cartridge 28 that mates with the reusable sleeve 22 when the two are engaged. When the disposable absorbent cartridge 28 needs to be removed, the initial displacement of the disposable absorbent cartridge 28 creates an annular space between the reusable sleeve 22 and the disposable absorbent cartridge 28, thus facilitating removal. Fluid flow through the housing 26 of FIG. 4F can be from bottom to top or from top to bottom.

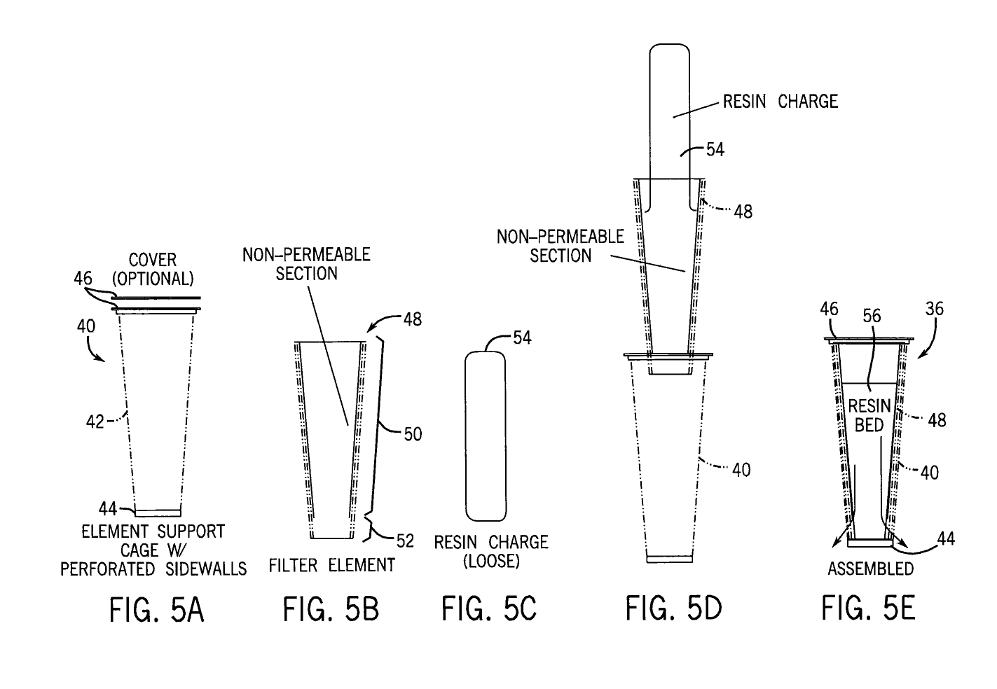

FIGS. 5A-5E illustrate the components of a delivery vehicle 36 for resin or other absorbent material according to an alternative embodiment of the invention. As shown in FIG. 5A, the delivery vehicle 36 can include an element support cage 40 with perforated sidewalls 42, a bottom portion 44, a top portion 46, and a cover 46 (which is an optional component). As shown in FIG. 5B, the delivery vehicle 36 can include a filter element 48. The filter element 48 can include two sections—an upper section 50 that is non-permeable and a lower section 52 that is permeable. The filter element 48 can be constructed of a suitable porous media, such as pleated or rolled porous media. As shown in FIG. 5C, the delivery vehicle 36 can include resin charge or other absorbent material 54 that is loose and can be used to fill or refill the filter element 48, as shown in FIG. 5D. FIG. 5E illustrates the assembled delivery vehicle 36 with a resin bed 56 inside the filter element 48, which is positioned inside the element support cage 40. As shown by the arrows in FIG. 5E, the lubricating and hydraulic fluids can flow from the top of the delivery system 36 through the resin bed 56, through the permeable lower portion 52 of the filter element 48, and through the perforated element support cage 40.

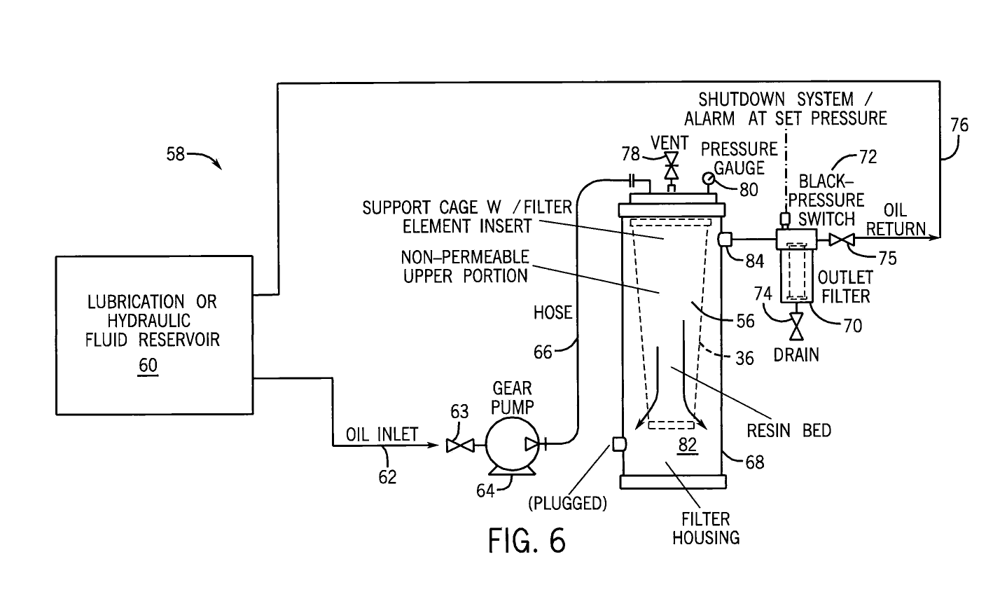

FIG. 6 illustrates a lubricating or hydraulic fluid distribution system 58 including the delivery vehicle 36 of FIGS. 5A-5E. The fluid distribution system 58 can include a fluid reservoir 60, an oil inlet hose 62, a first valve 63, a gear pump 64, a pump hose 66, a filter housing 68, an outlet filter 70, a back-pressure switch 72, a drain 74, a second valve 75, and an oil return hose 76. The filter housing 68 can house the delivery vehicle 36 and can include a vent 78 and a pressure gauge 80.

Fluid from the reservoir 60 can flow through the oil inlet hose 62 and the first valve 63 to the gear pump 64. The gear pump 64 can deliver fluid through the pump hose 66 to the filter housing 68. The fluid can enter the resin bed 56 and can flow downward past the non-permeable upper section 50 until it reaches the permeable lower section 52 of the filter element 48. The fluid can exit the permeable lower section 52 and flow through the perforated element support cage 40 to an interior portion 82 of the filter housing 68. The filtered fluid can then flow out of the filter housing 68 through an outlet port 84. The filtered fluid can flow to the outlet filter 70, which can be used to capture any resin that may escape or carryover from the resin bed 56. The outlet filter 70 can include a discharge screen and/or a filter cartridge. If the pressure in the outlet filter 70 exceeds a threshold, the back-pressure switch 72 can generate a signal and shutdown the system, if necessary.

The system 58 can be used to continuously filter the lubricating or hydraulic fluid used in a turbine or hydraulic system. The fluid can be continuously treated to reduce the likelihood that the turbine or hydraulic system becomes damaged due to the use of a contaminated lubricating fluid. Alternatively, the fluid may be recirculated for one or more periodic treatments.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

1. A delivery system for removing contaminants from lubricating and hydraulic fluids, the delivery system comprising:
a reusable sleeve;
a first end cap and a second end cap coupled to the reusable sleeve; and
a disposable absorbent cartridge containing absorbent material capable of removing contaminants from lubricating and hydraulic fluids,
the disposable absorbent cartridge removeably positioned inside the reusable sleeve between the first end cap and the second end cap,
the disposable absorbent cartridge being constructed of a material permeable to the lubricating and hydraulic fluids.

2. The delivery system of claim 1 wherein the absorbent material is constructed of at least one of a needle-punched polymeric felt, a polymeric screen, and a non-woven and calendared polymeric media.

3. The delivery system of claim 1 wherein the disposable absorbent cartridge includes an ion exchange resin.

4. The delivery system of claim 1 wherein the disposable absorbent cartridge is refillable by opening a top portion, pouring out the absorbent material, and refilling the absorbent material.

5. The delivery system of claim 1 wherein the absorbent material includes an ion exchange resin based on at least one of polyacrylamide, polyacrylate, and polystyrene polymers.

6. The delivery system of claim 1 wherein the absorbent material includes at least one of fuller's earth, diatomeaceous earth, and bentonite.

7. The delivery system of claim 1 wherein the absorbent material includes at least one of activated alumina, silica gel, alumino-silicate, activated carbon, modified activated carbon, and magnesium silicate.

8. The delivery system of claim 1 wherein the absorbent material removes contaminants less than about one micron in size from lubricating and hydraulic fluids.

9. The delivery system of claim 1 and further comprising a housing within which the reusable sleeve is positioned.

10. The delivery system of claim 9 wherein the disposable absorbent cartridge includes a handle to facilitate removal from the housing.

11. The delivery system of claim 1 wherein the disposable absorbent cartridge includes a cylindrical portion with a first flap and a second flap, the first flap and the second flap being joined to seal the absorbent material within the disposable absorbent cartridge.

12. The delivery system of claim 11 wherein the first flap and the second flap are joined by a closure device, the closure device capable of being opened to refill the absorbent material.

13. The delivery system of claim 1 wherein the reusable sleeve and the disposable absorbent cartridge are conically-shaped.

14. A delivery system for removing contaminants from lubricating and hydraulic fluids, the delivery system comprising:
a filter housing;
a perforated element support cage positioned inside the filter housing; and
a filter element removeably positioned inside the perforated element support cage,
the filter element including an upper non-permeable section and a lower permeable section, the lower permeable section being constructed of a material permeable to the lubricating and hydraulic fluids,
the filter element receiving absorbent material capable of removing contaminants from lubricating and hydraulic fluids.

15. The delivery system of claim 14 wherein the filter housing is in fluid communication with a fluid reservoir.

16. The delivery system of claim 14 wherein the filter housing is in fluid communication with an outlet filter and a back-pressure switch, the back-pressure switch capable of sensing increased pressure due to absorbent material escaping from the filter housing.

17. The delivery system of claim 16 wherein the back-pressure switch is capable of generating a signal to shut down the system if the increased pressure exceeds a threshold.

18. The delivery system of claim 14 wherein the filter element is constructed of at least one of a needle-punched polymeric felt, a polymeric screen, and a non-woven and calendared polymeric media.

19. The delivery system of claim 14 wherein the filter element is refillable by opening a top portion of the filter housing, pouring out the absorbent material, and refilling the absorbent material.

20. The delivery system of claim 14 wherein the absorbent material includes an ion exchange resin based on at least one of polyacrylamide, polyacrylate, and polystyrene polymers.

21. The delivery system of claim 14 wherein the absorbent material includes at least one of fuller's earth, diatomeaceous earth, and bentonite.

22. The delivery system of claim 14 wherein the absorbent material includes at least one of activated alumina, silica gel, alumino-silicate, activated carbon, modified activated carbon, and magnesium silicate.

23. The delivery system of claim 14 wherein the absorbent material removes contaminants less than about one micron in size from lubricating and hydraulic fluids.
